(19) United States
(12) Patent Application Publication
(10) Pub. No.: US 2008/0298875 A1
(43) Pub. Date: Dec. 4, 2008

(54) MODULAR WORKBOARD THERMAL PRINTER SYSTEM

(75) Inventors: XIAONONG QIAN, Mukilteo, WA (US); MICHAEL WELLS, Everett, WA (US)

Correspondence Address: SHOOK, HARDY & BACON, L.L.P.;(C/O INTERMEC), INTELLECTUAL PROPERTY DEPARTMENT, 2555 GRAND BLVD., KANSAS CITY, MO, 64108, US

(73) Assignee: INTERMEC TECHNOLOGIES CORPORATION, Everett, WA (US)

(21) Appl. No.: 12/128,734

(22) Filed: May 29, 2008

Related U.S. Application Data
(60) Provisional application No. 60/941,453, filed on Jun. 1, 2007.

(51) Int. Cl. B41J 29/02

(52) U.S. Cl. 400/693

(57) ABSTRACT

A modular workboard thermal printer system provides a user with portable computing and printing capabilities. According to one aspect, the modular workboard thermal printer system includes a housing to which a thermal printer module may be operatively coupled, and a receiving portion formed with the housing for accepting therein a portable computing device that interfaces with the thermal printer module. Further, the modular workboard thermal printer system possesses an input/output panel for electrically connecting external devices with the thermal printer module and/or the portable computing device, as well as a power supply for delivering electrical power to the thermal printer module and optionally to other devices connected with the housing.

### CROSS-REFERENCE TO RELATED APPLICATIONS

This application claims priority to commonly owned U.S. provisional application Ser. No. 60/941,453, filed Jun. 1, 2007, incorporated by reference herein.

### STATEMENT REGARDING FEDERALLY SPONSORED RESEARCH OR DEVELOPMENT

None.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Various embodiments of the present invention are directed to a portable, modular workboard thermal printer system possessing connectivity features for interfacing with external electronic devices. According to one aspect, the portable, modular workboard thermal printer system includes a housing and a thermal printer module operatively coupled with the housing. The system further includes a receiving portion formed with the housing for accepting therein a portable computing device that interfaces with the thermal printer module, as well as an input/output panel for electrically connecting external devices with the thermal printer module and/or the portable computing device. Additionally, the system includes a bus for transporting electrical signals between at least some of the thermal printer module, the portable computing device, and the input/output panel, and a power supply for delivering electrical power to the thermal printer module and optionally to other devices connected with the housing.

In another aspect, the portable, modular workboard thermal printer system includes a housing and a thermal printer module operatively coupled with the housing. The system further includes a holder module formed with the housing for accepting therein a portable computing device, as well as a connector portion for electrically connecting external devices with the thermal printer module and/or the portable computing device. A power supply is also provided for delivering electrical power to at least the thermal printer module.

Additional advantages and features of the invention will be set forth in part in a description which follows, and in part will become apparent to those skilled in the art upon examination of the following, or may be learned by practice of the invention.

### BRIEF DESCRIPTION OF THE DRAWINGS

In the accompanying drawings which form a part of the specification and are to be read in conjunction therewith, and in which like reference numerals are used to indicate like parts in the various views:

FIG. 1 is a top plan view of a modular workboard thermal printer system, in accordance with an embodiment of the present invention;

FIG. 2 is a bottom plan view of the modular workboard thermal printer system of FIG. 1;

FIG. 3 is a top perspective view of the modular workboard thermal printer system of FIG. 1, showing the HHC in the stowage position;

FIG. 4 is a top perspective view of the modular workboard thermal printer system of FIG. 1, showing the HHC in the removable position;

FIG. 5 is top a perspective view of a thermal printer module of the modular workboard thermal printer system, in accordance with an embodiment of the present invention;

FIG. 6 is top perspective view of the thermal printer module of FIG. 5, showing the pivoting of the top cover of the module;

FIG. 7 is a top perspective view of another embodiment of modular workboard thermal printer system for detachable coupling with the thermal printer module of FIG. 5, in accordance with an embodiment of the present invention; and

FIG. 8 is a bottom perspective view of the modular workboard thermal printer system of FIG. 7.

### DETAILED DESCRIPTION

A modular workboard thermal printer system, in various embodiments, provides a portable, self-contained device for performing various computing tasks and printing out as a hardcopy the results of such tasks. In broad terms, certain embodiments of the modular workboard thermal printer system include a housing for containing a thermal printer module, a receiving slot for a portable computing device or the like (referred to herein as a “hand held computer” or “HHC”) a bus and associated conductive contacts for electrically coupling the portable computing device to the thermal printer module, various input and output ports, and a power supply for providing electrical power to at least one of the thermal printer module and the portable computing device coupled to the system.

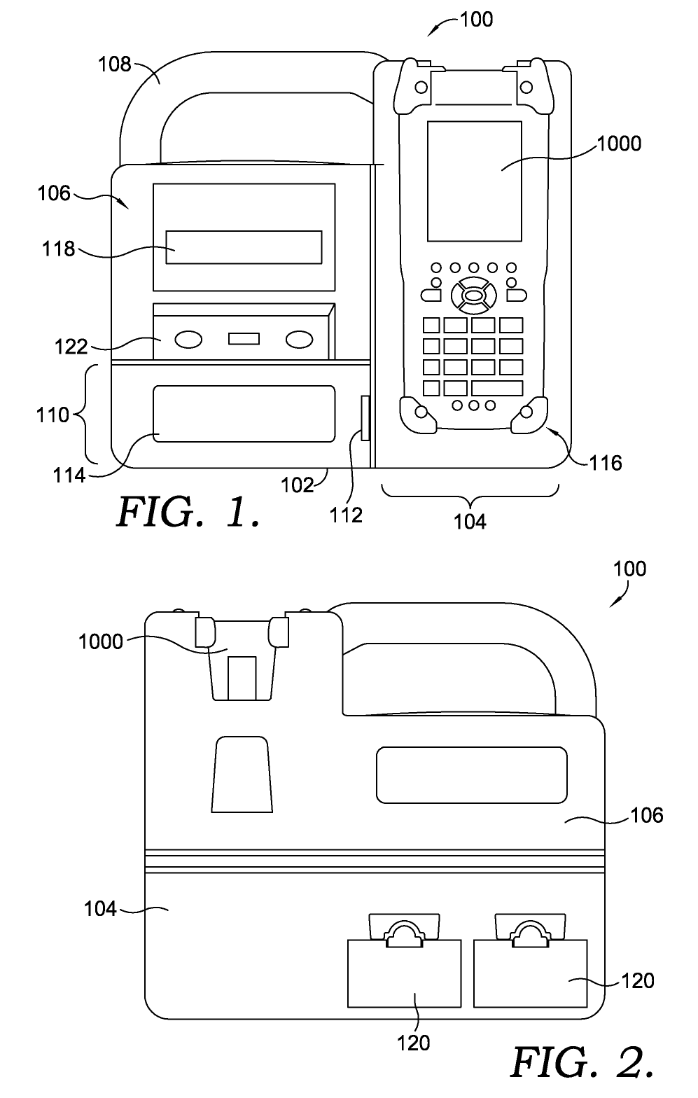

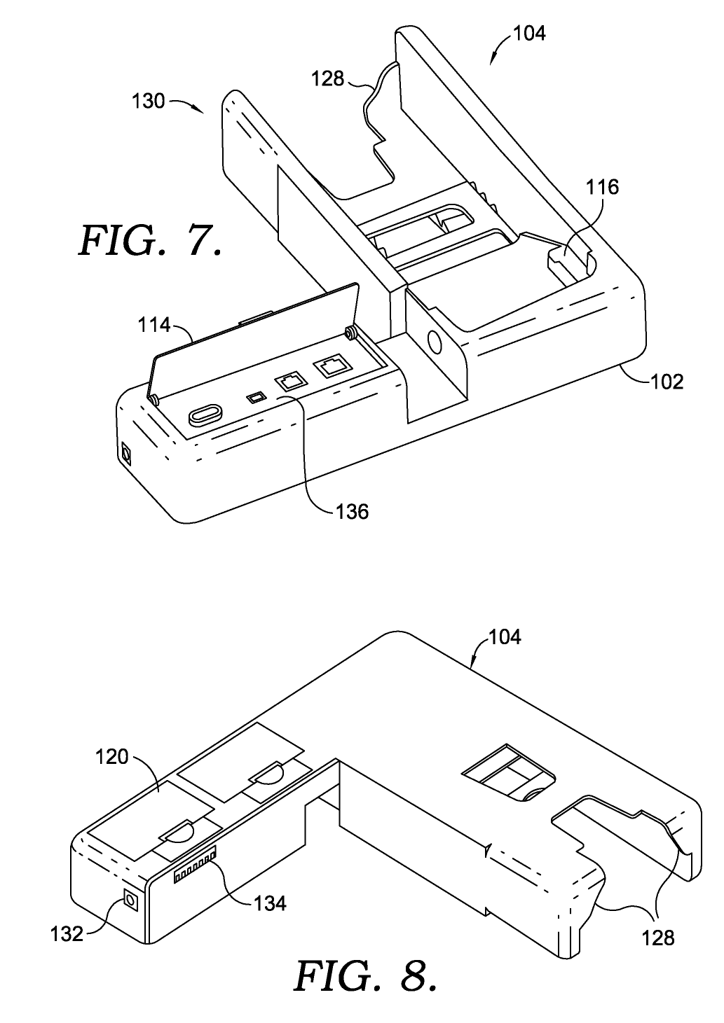

Turning now to FIGS. 1-8, various embodiments of the modular workboard thermal printer system 100 (referred to herein as the “system 100”) are depicted. In particular, one embodiment of the system 100 shown in FIGS. 1 and 2 broadly includes a housing 102, an HHC holder module 104 functioning as a receiving slot for an HHC 1000, and a thermal printer module 106 mounted with the housing 102 and electrically coupled to the HHC 1000 through a standard electrical communication bus (not shown). The housing 102 is formed with a carrying handle 108, as well as a connector portion 110 formed below the thermal printer module 106. The connector portion 110 functions as the interface for connecting the system 100 to various electronic devices, and includes a number of input and output ports formed on an Input/Output (I/O) panel 136 (e.g., for transmitting data to and/or exporting data from the HHC 1000 or printer module 106) that connect with a bus of the system 100 formed within the housing 102. The connector portion 110 further includes a card reader module 112 for receiving data cards on the system 110 (e.g., swiped cards having a magnetic strip for storing information), as well as a pivotable panel door 114 (see FIG. 7) for concealing and protecting the I/O panel 136 from the external environment. Preferably, the I/O panel 136 is positioned adjacent to the HHC holder module 104 and the thermal printer module 106, and faces the same direction for ease of connecting external devices with the system 100 when the thermal printer module 106 and/or the HHC 1000 are in use. As can be appreciated, the housing 102 may be formed of various lightweight and rigid materials possessing impact resistance, preferably of a non-electrically conductive material, such as plastics or composites.

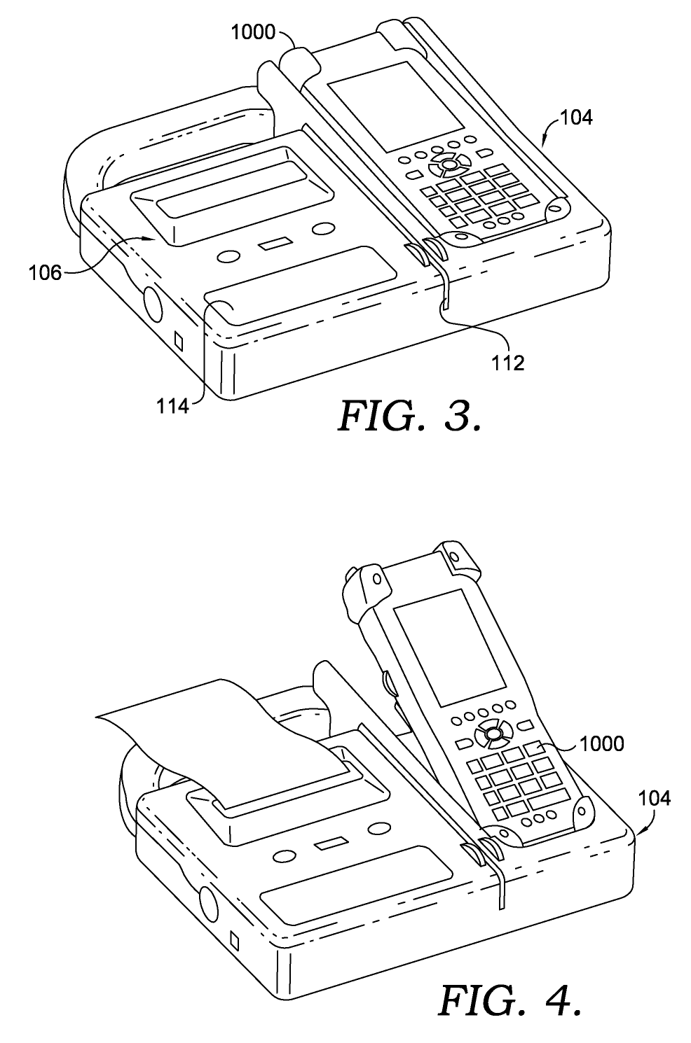

With additional reference to FIGS. 3, 4 and 7, the HHC holder module 104 is formed with a pivotable sleeve or liner 116 in which the HHC 1000 is slidably received. When the liner 116 and HHC 1000 received therein are pivoted upwardly away from the remainder of the housing 102 (from the stowage position shown in FIG. 3 to the removable position shown in FIG. 4), the HHC 1000 may be slid out of the liner 116 and thereby decoupled from the system 100. Additionally, the up-tilted position, the user can view the display screen of the HHC 1000 and provide input on the keypad of the HHC 1000 with greater ease when the housing 102 is in the horizontal position on a surface.

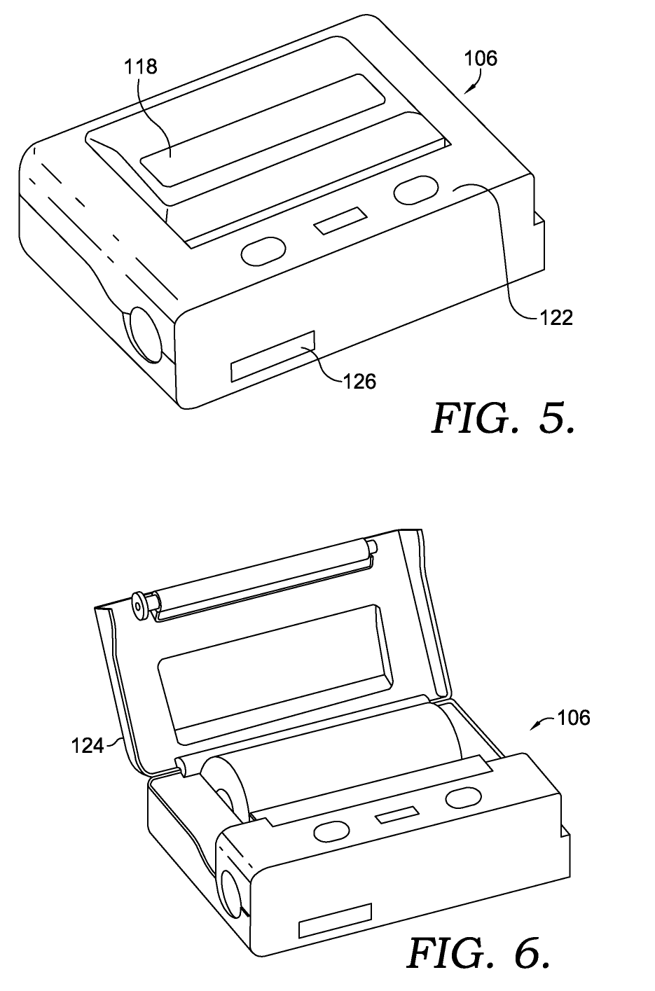

Turning to FIGS. 5 and 6, the thermal printer module 106 is formed with a thermal printer and a signature capturing pad 118. In certain embodiments, the pad 118 may be a “passive” surface through which the printed paper substrate passes a pressure-sensitive “active” pad. In the case of the pad 118 being a “passive” surface, the pad 118 simply acts as a directional marker for the user to sign with a writing instrument on a paper strip located on the pad. Alternatively, the pad 118 being in the form of a pressure-sensitive “active” pad 118 captures the result of a signature via a stylus with a sensing membrane of the pad 118 and processes the captured signature to store the signature electronically. For instance, the capture signature may be relayed along a communication bus (not shown) formed with the housing 102 to the HHC 1000. As explained in further detail herein, electrical connectors are provided on the housing 102 for both the thermal printer module 106 and the HHC 1000, with the bus formed therebetween, in order to carry data signals between the HHC 1000 and the thermal printer module 106. The signature capturing pad 118 may also be illuminated (e.g., by an LED, electroluminescence, or other light source) to assist the user in viewing the pad 118 area and indicating the location where the user is to sign.

With continued reference to FIGS. 5 and 6, and additional reference to FIGS. 7 and 8, a power supply 120 for the system 100 preferably takes the form of one or more batteries for powering at least the thermal printer module 106 and optionally, the HHC 1000 as well. In one embodiment, the power supply 120 is of the same configuration as a common battery for the HHC 1000 (e.g., a rechargeable lithium-ion battery, a nickel-cadmium battery, a nickel metal hydride battery, etc). The power supply 120 connects to a power circuit (not shown) to deliver power to connectors interfacing with the thermal printer module 106 and the HHC 1000. For instance, the power circuit may be another bus separate from the bus delivering data signals to the thermal printer module 106 and the HHC 1000, but may interface with the same connectors (i.e., different conductive contacts on same connectors). In certain embodiments, the thermal printer module 106 has either a minimal internal power source or no power source, such that the primary or whole power source for operation of the thermal printer module 106 is provided by the power supply 120. In an alternative embodiment, the communication between the HHC 1000 and the thermal printer module 106 may be accomplished wirelessly, instead of through a wired bus. For instance, the communication may be accomplished through transceivers via radio-frequency waves, or by any other short range wireless communication method (e.g., infrared, or other means).

The thermal printer module 106, shown separated from the housing 102 in FIGS. 5 and 6, has an Input/Output (I/O) panel 122, a pivoting top cover 124 for access to paper rolls loaded with the module 106, and an electrical connector 126 having a plurality of conductive channels. The connector 126 of the module 106 interfaces with a mating connector 134 on the housing 102 when the module 106 is coupled with the housing 102, with the system 100 communication bus coupled with the connector 134. The module connector 126 has separate channels for both electrical power (received from the power supply 120) and data communication (e.g., traveling across the communication bus from the connector portion 110 and/or the HHC 1000). Additionally, a connector (not shown) for the HHC 1000 may take the same form as the connector 126, and is formed at the base of the HHC holder module 104 on the housing 102. As seen in FIGS. 7 and 8, a pair of flanged retaining members 128 are formed at an upper region 130 of the housing 102 to serve as a physical retainer for the HHC 1000 positioned within the pivotable liner 116 and in the lowered position shown in FIG. 3. This prevents the HHC 1000 from being unintentionally decoupled from the housing 102, as it is only removable when the liner 116 is in the up-tilted position. A common power connector 132 may be formed in the housing 102 proximal to the power supply 120, so that an external power cord may be connected therewith to supply power to recharge the batteries of the power supply 120 (e.g., from an electrical utility source, another battery, or other power source).

As can be understood, the thermal printer module 106 may be permanently affixed with the housing 102 (as shown in the embodiment of the system 100 depicted in FIGS. 1-4) or may be detachably coupled with the housing 102 (as shown in an alternative embodiment of the system 100 depicted in FIGS. 7 and 8).

In a further embodiment, the HHC holder module 104 is not permanently formed with or attached to the housing 102, but is a separate structure detachable from the housing via any suitable structural attachment or coupling means. Specifically, the detachable holder module 104 ensures that the HHC 1000 may be connected with the housing 102 in the region of the connector panel 110, ensuring electrical coupling with the I/O panel 136, the battery 120, and the bus connecting to the thermal printer module 106. When the system 100 does not have a permanently attached HHC holder module 104, the system 100 forms a fully functioning stand-alone thermal printer system.

The modular workboard thermal printer system 100, in certain embodiments, provides the user with a single type of power source through the power supply 120, so that separate batteries, or battery types, for the thermal printer and HHC are not necessary when both devices are connected to the system 100. Additionally, in certain embodiments, the use of two batteries 120, or one battery 120 of the system 100 and the battery of the HHC 1000, allows the thermal printer to continue functioning when one of the batteries 120 is fully discharged or has been removed.

As can be appreciated, various embodiments of the modular workboard thermal printer system 100 enable portable computing and interfacing of multiple devices capable of printing through a thermal printer module. Furthermore, since certain changes may be made in the above invention without departing from the scope hereof, it is intended that all matter contained in the above description or shown in the accompanying drawing be interpreted as illustrative and not in a limiting sense.

We claim:

1. A portable, modular workboard thermal printer system, comprising:
a housing;
a thermal printer module operatively coupled with the housing;
a receiving portion formed with the housing for accepting therein a portable computing device;
an input/output panel formed with the housing for electrically connecting external devices with at least one of the thermal printer module and the portable computing device;
a bus disposed with the housing for transporting electrical signals between at least two of the thermal printer module, the portable computing device, and the input/output panel; and
a power supply disposed with the housing for delivering electrical power to at least the thermal printer module.

2. The system of claim 1, wherein the receiving portion includes a module formed with a receiving slot.

3. The system of claim 2, wherein the module of the receiving portion is formed with a pivotable liner for slidably receiving therein the portable computing device and moving the portable computing device to different positions.

4. The system of claim 1, further comprising a secondary input/output panel associated with the thermal printer module.

5. The system of claim 1, further comprising a card reader module formed on the housing and electrically coupled with the bus.

6. The system of claim 1, wherein the thermal printer module includes a signature capturing pad.

7. The system of claim 1, wherein the thermal printer module is configured for detachment from the housing.

8. The system of claim 1, wherein the receiving portion of the housing has at least one retaining member to inhibit the removal of the portable computing device from the receiving portion.

9. A portable, modular workboard thermal printer system, comprising:
a housing;
a thermal printer module operatively coupled with the housing;
a holder module formed with the housing for accepting therein a portable computing device;
a connector portion formed with the housing for electrically connecting external devices with at least one of the thermal printer module and the portable computing device; and
a power supply disposed with the housing for delivering electrical power to at least the thermal printer module.

10. The system of claim 9, wherein the holder module is formed with a pivotable liner for slidably receiving therein the portable computing device moving the portable computing device to different positions.

11. The system of claim 9, further comprising a bus disposed with the housing for transporting electrical signals between at least two of the thermal printer module, the portable computing device, and the input/output panel.

12. The system of claim 9, further comprising a secondary input/output panel associated with the thermal printer module.

13. The system of claim 9, further comprising a card reader module formed on the housing and electrically coupled with the bus.

14. The system of claim 9, wherein the thermal printer module includes a signature capturing pad.

15. The system of claim 9, wherein the thermal printer module is configured for detachment from the housing.

16. The system of claim 9, wherein the holder module has at least one retaining member to inhibit the removal of the portable computing device from the holder module.
